(19) United States
(12) Patent Application Publication
(10) Pub. No.: US 2006/0198950 A1
(43) Pub. Date: Sep. 7, 2006

(54) Method of manufacturing patterned recording medium

(75) Inventor: Byung-kyu Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/367,452

(22) Filed: Mar. 6, 2006

(30) Foreign Application Priority Data
Mar. 4, 2005 (KR) 10-2005-0018129

(51) Int. Cl. B05D 5/12; G03C 5/00

(52) U.S. Cl. 427/130; 427/128; 430/315; 430/396; 219/121.6

(57) ABSTRACT

Provided is a method of manufacturing a patterned recording medium. The method includes depositing a magnetic thin film on a substrate, aligning a hard mask that has a plurality of penetration holes regularly distributed therein above the magnetic thin film, irradiating the hard mask, and removing the hard mask.

### CROSS-REFERENCE TO RELATED PATENT APPLICATION

This application claims the benefit of Korean Patent Application No. 10-2005-0018129, filed on Mar. 04, 2005, in the Korean Intellectual Property Office, the disclosure of which is incorporated herein in its entirety by reference.

### BACKGROUND OF THE INVENTION

1. Field of the Invention

The present invention relates to a method of manufacturing a data recording medium, and more particularly, to a method of manufacturing a patterned recording medium.

2. Description of the Related Art

Rapid growth in internet operational technologies and the replacement of conventional metal coaxial cables with optical fibers as data transmission wires enable users to access abundant information in a shorter time.

Recent development of wireless connection techniques for the internet using portable communication equipment or notebook computers enables users to obtain desired information via the internet from anywhere. As the amount of information accessed via the internet connection and the data transmission rate have increased, high-density recording media, which can rapidly record more information in relatively small areas, and computers or communication equipment using the same have been introduced.

Hard disks are universally used as recording media internally or externally installed in computers. Hard disks are also used as portable data recording units. Data are recorded in units of bits on a magnetic thin film in a hard disk. When a bit data, for example ‘1’, is recorded on a region of the magnetic thin film, a magnetic dipole in the region is aligned in a predetermined direction. To increase the data recording density of a hard disk, the area of the region where the bit data is recorded in the magnetic thin film should be decreased while maintaining the reliability of the bit data recorded on the magnetic thin film. To satisfy this demand, interactions between the regions of the magnetic thin film storing the bit data and the influence of reading or recording bit data from or to a given region upon other recorded regions of the magnetic thin film should be minimized.

Accordingly, a recording medium having a patterned magnetic thin film in which data recording regions are separated from each other (hereinafter, referred to as a patterned recording medium) has been recently introduced. The patterned recording medium has a high recording density and is manufactured using a photolithography method, a nano-imprinting method, a self-ordered magnetic array (SOMA) method, or a laser patterning method. However, the uses of such methods have limitations for mass production, reducing the size of data recording regions, and obtaining desired throughput. In particular, the laser patterning method is advantageous in that a patterning process used is simple and surfaces of obtained patterns are usually continuous, but is disadvantageous in that it is difficult to reduce the pattern size to less than 100 nm and to decrease the pitch of the pattern suitably for a high-density recording medium. In addition, three incident beams are required to obtain a circular pattern such that an apparatus used for the laser patterning method may be larger and complicated.

### SUMMARY OF THE INVENTION

The present invention provides a method of manufacturing a recording medium that allows the reduction of sizes and pitches of regions (hereinafter, patterns) where bit data is recorded in a magnetic film and is simple.

According to an aspect of the present invention, there is provided a method of manufacturing a patterned recording medium, the method including: depositing a magnetic thin film on a substrate; aligning a hard mask that has a plurality of penetration holes regularly distributed therein above the magnetic thin film; irradiating the hard mask; and removing the hard mask.

The diameters of the penetration holes may be less than 100 nm. The pitches of the penetration holes may be of a nanometer scale. The magnetic anisotropic energy of the magnetic thin film may be in the range of 5×10⁴ to 5×10⁸ erg/cc.

Light irradiated onto the hard mask may be a laser beam having a wavelength greater than the diameters of the penetration holes.

The laser beam may be emitted, using a CO₂ laser, an Nd:YAG laser, a He—Ne laser, a N₂ laser, a HF laser, or a DF laser.

Lenses may be formed in at least one of outlets and inlets of the penetration holes.

The hard mask may contact the magnetic thin film.

The hard mask may be formed using anodic aluminum oxidization (AAO).

The present invention can simultaneously form patterns on a magnetic thin film of a recording medium in a single process. Accordingly, since the process of forming patterns is simple, the production of the recording media can be increased. In addition, since the sizes and pitches of the patterns formed in the magnetic thin film are determined according to the sizes and pitches of holes formed on a hard mask, the sizes of the patterns can be reduced to less than 100 nm and the pitches of the patterns can be also decreased. In particular, since the patterns are simultaneously formed using the hard mask, the patterns can be regularly formed, thereby increasing the density of the patterns, and increasing the recording density of the recording medium.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view of a preliminary recording medium and a hard mask for a method of manufacturing a patterned recording medium according to an embodiment of the present invention;

FIG. 2 is a plane view of the hard mask illustrated in FIG. 1;

FIG. 3 is a cross-sectional view illustrating the incidence of laser beams on the recording medium of FIG. 1;

FIG. 4 is a plan view illustrating when directions of magnetic dipoles in patterns formed on a magnetic thin film of the recording medium of FIG. 3 are parallel to the surface of the magnetic thin film;

FIG. 5 is a cross-sectional view of a preliminary recording medium and a hard mask for a method of manufacturing a patterned recording medium according to another embodiment of the present invention;

FIG. 6 is a plan view illustrating when directions of magnetic dipoles in patterns formed on the magnetic thin film of the recording medium of FIG. 3 are normal to the surface of the magnetic thin film;

FIG. 7 is a cross-sectional view of the recording medium sectioned along the line 7-7′ of FIG. 6;

FIGS. 8 through 10 are cross-sectional views of hard masks having lenses.

### DETAILED DESCRIPTION OF THE INVENTION

Hereinafter, the present invention will be described more fully with reference to the accompanying drawings, in which exemplary embodiments of the invention are shown. The sizes and thicknesses of layers and regions are exaggerated for clarity.

A method of manufacturing a patterned recording medium according to an embodiment of the present invention employs a laser patterning technology and a specific hard mask to manufacture a recording medium having desired patterns. The laser patterning technology is used for changing magnetic characteristics of a predetermined region of a magnetic thin film, for example, changing the region from a paramagnetic region to a ferromagnetic region. That is, a predetermined paramagnetic region is instantly heated up to a high temperature, for example, 500 to 2,000° C., using the laser, and becomes ferromagnetic. The ferromagnetic region on the magnetic thin film becomes a pattern where bit data is recorded.

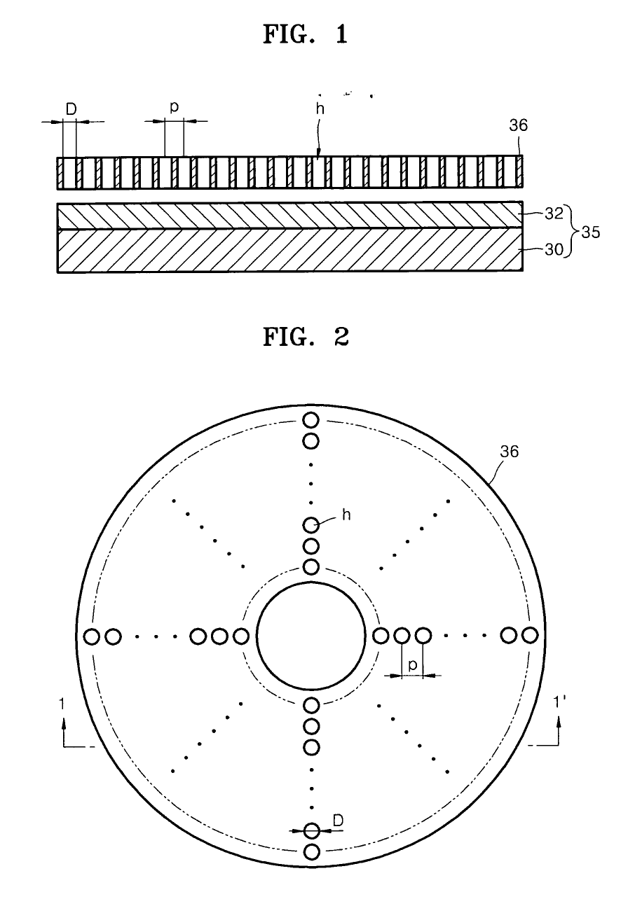

Referring to FIG. 1, in a method of manufacturing a patterned recording medium according to an embodiment of the present invention, a magnetic thin film 32 is deposited on a substrate 30 to form a preliminary recording medium 35. The magnetic thin film 32 may be a paramagnetic thin film and have a magnetic anisotropic energy of 5×10⁴ to 5×10⁸ erg/cc. Then, a hard mask 36 is aligned above the preliminary recording medium 35. The hard mask 36 is formed of, for example, an aluminum oxide layer, and has a thickness of 5 to 100 nm.

The hard mask 36 has a plurality of penetration holes h regularly distributed therein, as illustrated in FIG. 2. FIG. 1 illustrates a cross-section of the hard mask 36 sectioned along the line 1-1′ in FIG. 2. The penetration holes h can have various shapes and may be, for example, circular, elliptical or rectangular. The diameters D of the penetration holes h determine diameters of patterns formed on the magnetic thin film 32 in the following process, and are small, for example, less than 100 nm. In addition, the pitches p of the penetration holes h determine the pitches of the patterns formed on the magnetic thin film 32 and may be, for example, 25 nm.

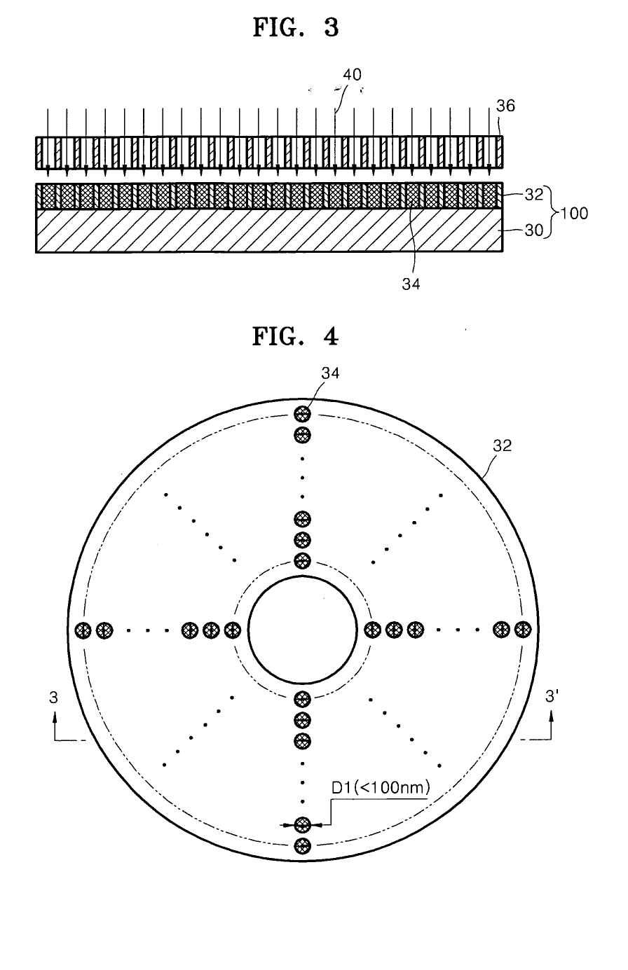

FIG. 3 is a cross-sectional view illustrating incidence of laser beams on the recording medium of FIG. 1. Referring to FIG. 3, the entire top surface of the aligned hard mask 36 is simultaneously irradiated with a uniform intensity of laser beams 40. One irradiation may be enough, but an additional irradiation can be performed if necessary. The laser beams 40 can be scanned across the hard mask 36, for example, from left to right. Then, the hard mask 36 is removed.

The incident laser beams 40 can be produced by a laser emitting a long wavelength laser beam, for example, a CO₂ laser, an Nd:YAG laser, a He—Ne laser, a N₂ laser, a HF laser, or a DF laser. The intensity of the laser beams 40 may be sufficient to instantly heat predetermined regions of the magnetic thin film 32 where the laser beams pass through the penetration holes h and, accordingly, make the predetermined regions ferromagnetic.

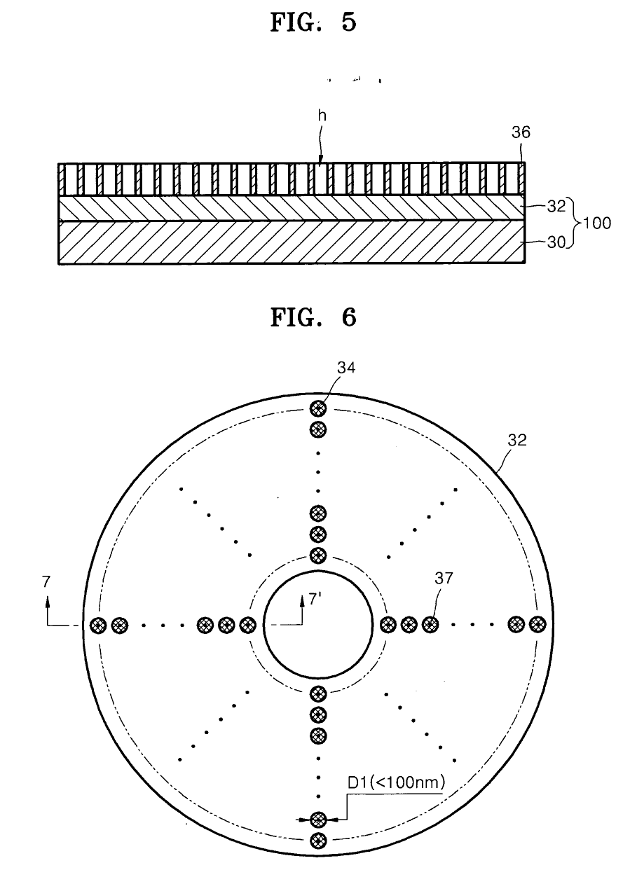

If the wavelength of the incident laser beams 40 is less than the diameters D of the penetration holes h, most of the laser beams 40 are scattered and few laser beams 40 penetrate the penetration holes h. Otherwise, if the wavelength of the incident laser beams 40 is greater than the diameters D of the penetration holes h, most of the laser beams 40 can reach the magnetic thin film 32 through the penetration holes h, as shown in FIG. 3. Although not illustrated in FIG. 3, some of the laser beams 40 can be diffracted through the penetration holes h, causing problems such as a reduction in the sharpness of the patterns. However, adjusting the irradiation conditions of the laser beams 40 and properly changing the distance between the hard mask 36 and the magnetic thin film 32 can overcome such problems. That is, if the hard mask 36 contacts the magnetic thin film 32 during the irradiation, as illustrated in FIG. 5, the influence of the diffraction can be insignificant. Thus, the irradiation efficiency of the incident laser beams 40 is higher in the case that the hard mask 36 contacts the magnetic thin film 32 than in the case that the hard mask 36 is separated from the magnetic thin film 32. Therefore, the electric power used for the incident laser beams 40 can be reduced when the hard mask 36 contacts the magnetic thin film 32.

As described above, the radiation of the laser beams 40 on the hard mask 36 forms ferromagnetic regions 34 having identical shapes, diameters, and pitches, and a uniform distribution on the magnetic thin film 32, thus forming a patterned recording medium 100 having the patterns of the ferromagnetic regions 34. A protective layer (not illustrated) can be formed on the magnetic thin film 32 of the patterned recording medium 100 in the following process.

FIG. 4 is a plan view of the magnetic thin film 32 having the patterns 34 of the patterned recording medium 100. FIG. 3 is a cross-section of the hard mask 36 and the patterned recording medium 100 along the line 3-3′ in FIG. 4. The patterns in FIG. 4 are exaggerated for clarity. Referring to FIG. 4, the patterns 34 are circular, and are regularly distributed on the magnetic thin film 32. The diameters D₁ of the patterns 34 are less than 100 nm. In addition, FIG. 4 illustrates magnetic dipoles of the patterns 34 formed on the magnetic thin film 32 in the case of a parallel magnetic recording medium. Arrows in the circles indicate the direction of the magnetic dipoles of the patterns 34 aligned in a certain direction by magnetization. If the directions of the arrows in the circles illustrated in FIG. 4 indicate the case of bit data ‘1’, arrows in the opposite direction would indicate bit data ‘1’. In the case of a vertical magnetic recording medium, magnetic dipoles of patterns formed on a magnetic thin film 32 are normal to the surface of the magnetic thin film 32, as shown in FIG. 6, not parallel to the surface of the magnetic thin film 32 as illustrated in FIG. 4.

Spots 37 in the patterns 34 of FIG. 6 indicate magnetic dipoles 37 of the patterns 34 directed upward and normal to the surface of the magnetic thin film 32. FIG. 7 illustrates a cross-section of the pattern 34 sectioned along the line 7-7′ in FIG. 6. The direction of the magnetic dipoles of FIG. 6 are clearly shown in FIG. 7. As illustrated in FIG. 7, if the magnetic dipoles 37 of the patterns 34 directed upward with respect to the surface of the magnetic thin film 32 indicates the case of recording bit data ‘0’, when bit data ‘1’ are recorded to some of the patterns using a data recording/reproducing unit including a magnetic head or a probe, the magnetic dipoles 37 of the selected patterns 34 are directed downward.

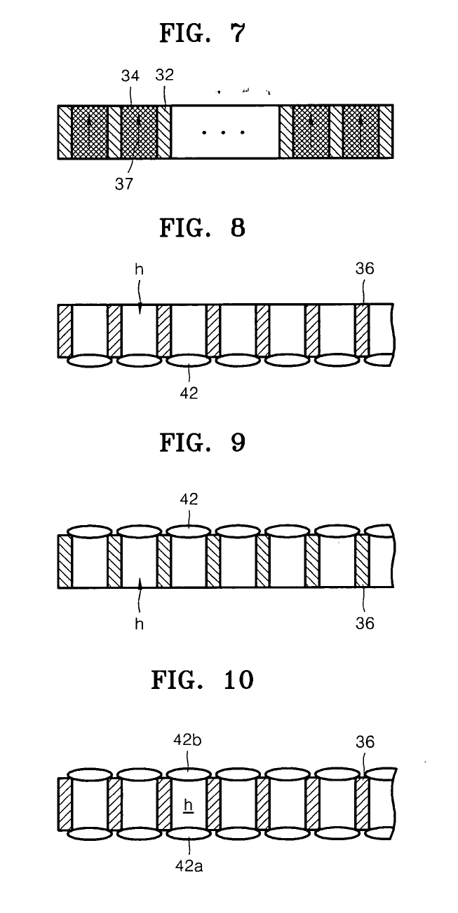

As illustrated in FIGS. 8 and 9, lenses 42 can be formed in the hard mask 36 used for forming the patterns 34 on the magnetic thin film 32. In particular, the lenses 42 can be formed at outlets or inlets of the penetration holes h formed in the hard mask 36. When the lenses 42 are formed in the hard mask 36, the magnetic thin film 32 can be separated from the hard mask 36 according to focal lengths and depths of the lenses 42, and spot sizes of the laser beams 40 can be reduced. Accordingly, the patterns 34 formed on the magnetic thin film 32 can have a higher resolution, thus enhancing the data recording density of the recording medium 100. In addition, as illustrated in FIG. 8, when the lenses 42 are formed at the outlets the penetration holes h in the hard mask 36, the incident laser beams 40 are respectively converged by the lenses 42 immediately after penetrating the penetration holes h, thereby eliminating diffraction of the laser beams 40. Accordingly, the efficiency of using the laser beams 40 is increased.

Otherwise, as illustrated in FIG. 10, first lenses 42a and second lenses 42b may be formed at the outlets and inlets of the penetration holes h formed in the hard mask 36, respectively. Focal lengths of the first and second lenses 42a and 42b may be different.

The magnetic thin film 32 formed on the recording medium 100 may be substituted by other data writable materials, for example, a ferroelectric thin film. A material layer may be disposed between the substrate 30 and the magnetic thin film 32 to assist in forming the pattern 34.

As described above, in the method of manufacturing a patterned recording medium, the hard mask 36 is used to simultaneously form a plurality of patterns. Accordingly, the recording medium can be manufactured in a short time and in large quantities by using the method of the present invention. In addition, since the diameters D and the pitches p of the penetration holes h can be set as desired when manufacturing the hard mask 36, the penetration holes h can be formed with various shapes. The patterns in the patterned recording medium can be circular, the sizes of the patterns can be less than 100 nm, and the pitches of the patterns can be of a nano scale, for example, about 25 nm. Accordingly, the method of manufacturing a patterned recording medium according to the present invention can produce a reliable recording medium having a high data recording density.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of manufacturing a patterned recording medium, the method comprising:
depositing a magnetic thin film on a substrate;
aligning a hard mask that has a plurality of penetration holes regularly distributed therein above the magnetic thin film;
irradiating the hard mask; and
removing the hard mask.

2. The method of claim 1, wherein the diameters of the penetration holes are less than 100 nm.

3. The method of claim 1, wherein the pitches of the penetration holes are of a nanometer scale.

4. The method of claim 1, wherein the magnetic anisotropic energy of the magnetic thin film is in the range of 5×10⁴ to 5×10⁸ erg/cc.

5. The method of claim 1, wherein light irradiated onto the hard mask is a laser beam having a wavelength greater than the diameters of the penetration holes.

6. The method of claim 5, wherein the laser beam is emitted using a CO₂ laser, an Nd:YAG laser, a He—Ne laser, a N₂ laser, a HF laser, or a DF laser.

7. The method of claim 1, wherein lenses are formed in at least one of outlets and inlets of the penetration holes.

8. The method of claim 1, wherein the hard mask contacts the magnetic thin film.

9. The method of claim 1, wherein the hard mask is formed using anodic aluminum oxidization (AAO).
